(19) United States
(12) Patent Application Publication
(10) Pub. No.: US 2019/0178814 A1
(43) Pub. Date: Jun. 13, 2019

(54) STATE ASSESSING DEVICE, STATE ASSESSING METHOD, AND STORAGE MEDIUM FOR STORING PROGRAM

(71) Applicant: NEC Corporation, Minato-ku, Tokyo (JP)

(72) Inventors: Gaku NAKANO, Tokyo (JP); Subhajit CHAUDHURY, Tokyo (JP)

(73) Assignee: NEC Corporation, Minato-ku, Tokyo (JP)

(21) Appl. No.: 16/310,847

(22) PCT Filed: Jun. 21, 2017
(86) PCT No.: PCT/JP2017/022811

§ 371 Date: Dec. 18, 2018

(30) Foreign Application Priority Data
Jun. 23, 2016 (JP) 2016-124877

(51) Int. Cl. G01N 21/954; G01M 99/00; H04N 5/232

(52) U.S. Cl. CPC G01N 21/954; H04N 5/23254; G01M 99/008

(57) ABSTRACT

A state assessing device 100 includes: a parameter estimation unit 110 that estimates, using time-series images obtained by an image taking device taking images of a structure and a measured value of a distance from the image taking device to the structure, a motion parameter representing a relative motion of a surface of the structure with respect to the image taking device; and an abnormality determination unit 120 that determines an abnormality in the structure by using an estimation result of the motion parameter.

### TECHNICAL FIELD

The present invention relates to a state assessing device and a state assessing method for determining a state of a structure such as a tunnel or a bridge, and further relates to a storage medium storing a program for achieving the state assessing device and the state assessing method.

### BACKGROUND ART

Soundness of a structure, such as a tunnel or a bridge, made of concrete is known to be affected by a crack, flaking, an internal cavity, and the like developing on a surface of the structure. Therefore, to estimate the soundness of the structure accurately, it is necessary to detect a crack, flaking, an internal cavity, or the like of the structure accurately.

A crack, flaking, an internal cavity, and the like of the structure is detected by a visual inspection or a hammering test by an examiner, and the examiner needs to be close to the structure for inspection. This leads to problems such as an increase in an operation cost for preparing an environment enabling an operation in the air and loss of economic opportunities due to traffic control for setup of the environment for the operation. Therefore, there has been a demand for an inspection method in which the examiner can remotely inspect the structure.

As a method of estimating soundness of a structure remotely, there is a method based on image measurement. For example, PTL 1 discloses a technique of binarizing an image obtained by imaging a structure by an imaging means by using a predetermined threshold value, and of detecting from the image a part corresponding to a crack in the image.

PTL 2 and PTL 3 propose techniques of detecting a crack as a defect developing in a structure on the basis of a state of stresses in the structure by using video images. In addition, PTL 4 and NPL 1 to NPL 3 propose techniques of estimating a deteriorated state of a structure by means of motion estimation with respect to areas in a video image.

### CITATION LIST

### Patent Literature

[PTL 1] Japanese Unexamined Patent Application Publication No. 2003-035528
[PTL 2] Japanese Unexamined Patent Application Publication No. 2008-232998
[PTL 3] Japanese Unexamined Patent Application Publication No. 2006-343160
[PTL 4] PCT International Publication No. WO 2015/159469

### Non Patent Literature

[NPL 1] Zhen Wang, et al., “Crack-opening displacement estimation method based on sequence of motion vector field images for civil infrastructure deterioration inspection”, Image Media Processing Symposium, 1-1-17, 2014
[NPL 2] Hiroshi Imai, et al., “Structural internal deterioration detection with motion vector field images”, Proceedings of the 2015 Institute of Electronics, Information and Communication Engineers (IEICE) General Conference, Information and Systems Society (2), 15, 2015-02-24
[NPL 3] Hiroshi Imai, et al., “In-plane/out-of-plane displacement separation in structural internal deterioration detection with monocular motion vector field analysis”, Proceedings of the 2015 Institute of Electronics, Information and Communication Engineers (IEICE) Engineering Sciences Society/NOLTA Society Conference, Engineering Sciences, 139, 2015-08-25

### SUMMARY OF INVENTION

### Technical Problem

However, the techniques disclosed in the aforementioned PTL 1 and PTL 4 may detect only those visible on a surface, such as a crack appearing on a structure surface; therefore, it is difficult to detect flaking when the developing flaking appears to be a crack but actually extends inside the structure in a way that is parallel to the surface. In addition, it is also difficult to detect an internal cavity and the like, which is not visible on a surface, by using the technique disclosed in PTL 1.

In contrast, the techniques disclosed in PTL 2 and PTL 3 and NPL 1 to NPL 3 are capable of solving the problem of PTL 1; however, these techniques have following problems.

First, in the techniques disclosed in PTL 2, PTL 3, and NPL 1, for example, a video image of an underside (e.g. a floorboard) of a bridge is taken and abnormality detection is performed using the obtained video image. In this case, when a vehicle passes through, the bridge is deflected due to a load by the vehicle; consequently, an imaging distance changes and an imaging magnification ratio changes. Therefore, in these techniques, a problem occurs; the problem is that a motion (i.e. out-of-plane displacement) generated due to change in the imaging magnification ratio is added to a motion (i.e. in-plane displacement) of an area of a surface of a measured object.

In the techniques disclosed in NPL 2 and NPL 3, an abnormality is estimated after the out-of-plane displacement and the in-plane displacement are separated; thus, it is considered that the problem of the techniques disclosed in PTL 2, PTL 3, and NPL 1 may be solved.

However, in the techniques disclosed in NPL 2 and NPL 3, a precondition required to be satisfied is that an image taking device is directed perpendicularly to a bridge face and the out-of-plane displacement is dominant. Therefore, in the techniques disclosed in NPL 2 and NPL 3, a problem occurs: the problem is that an image of an object viewed in an oblique direction is not allowed to be taken. In addition, in these techniques, an abnormality is estimated after the out-of-plane displacement and the in-plane displacement are separated; consequently, a problem occurs: the problem is that an estimation error is tend to be accumulated.

An example of an object of the present invention is to provide a state assessing device, a state assessing method, and a program therefor, which are capable of remotely determining an abnormality in a structure in a non-contact manner without being affected by a condition of an image taking device while solving the aforementioned problem and separating the in-plane displacement and the out-of-plane displacement.

### Solution to Problem

In order to achieve the above-described object, a state assessing device includes: parameter estimation means for estimating, using time-series images obtained by an image taking device taking images of a structure and a measured value of a distance from the image taking device to the structure, a motion parameter representing a relative motion of a surface of the structure with respect to the image taking device; and abnormality determination means for determining an abnormality in the structure by using an estimation result of the motion parameter.

In order to achieve the above-described object, a state assessing method includes: performing parameter estimation including estimating, using time-series images obtained by an image taking device taking images of a structure and a measured value of a distance from the image taking device to the structure, a motion parameter representing a relative motion of a surface of the structure with respect to the image taking device; and performing abnormality determination including determining an abnormality in the structure by using an estimation result of the motion parameter.

In order to achieve the above-described object, a storage medium stores a program causing a computer to execute: a parameter estimation process of estimating, using time-series images obtained by taking images of a structure by an image taking device and a measured value of a distance from the image taking device to the structure, a motion parameter representing a relative motion of a surface of the structure with respect to the image taking device; and an abnormality determination process of determining an abnormality in the structure using an estimation result of the motion parameter. One aspect of the present invention may be achieved by the program stored in the aforementioned storage medium.

### Advantageous Effects of Invention

As described above, according to the present invention, an abnormality in the structure may be remotely determined in a non-contact manner without being affected by a condition of the image taking device while an in-plane displacement and an out-of-plane displacement are separated.

### BRIEF DESCRIPTION OF DRAWINGS

FIG. 1 is a block diagram illustrating a schematic configuration of a state assessing device according to a first example embodiment of the present invention.

FIG. 2 is a block diagram illustrating a specific configuration of a state assessing device according to a second example embodiment of the present invention.

FIG. 3A is a diagram for explaining a relationship between a first example of an abnormal state of a structure and a surface displacement.

FIG. 3B is a diagram for explaining a relationship between a second example of an abnormal state of the structure and a surface displacement.

FIG. 3C is a diagram for explaining a relationship between a third example of an abnormal state of the structure and a surface displacement.

FIG. 3D is a diagram for explaining a relationship between a fourth example of an abnormal state of the structure and a surface displacement.

FIG. 4 is a diagram for explaining an estimation process of a motion parameter in the second example embodiment of the present invention.

FIG. 5A is a diagram for explaining a deterioration determination process using a motion parameter in a state in which an amount of a deflection of the structure is sound in the example embodiments of the present invention.

FIG. 5B is a diagram for explaining the deterioration determination process using a motion parameter in a state in which an amount of a deflection of the structure is deteriorated in the example embodiments of the present invention.

FIG. 6 is a flowchart illustrating an operation of the state assessing device according to the second example embodiment of the present invention.

FIG. 7 is a block diagram illustrating an example of a computer for achieving the state assessing device according to the example embodiments of the present invention.

FIG. 8 is a flowchart illustrating an example of an operation of the state assessing device according to the first example embodiment of the present invention.

### EXAMPLE EMBODIMENT

### Example Embodiments

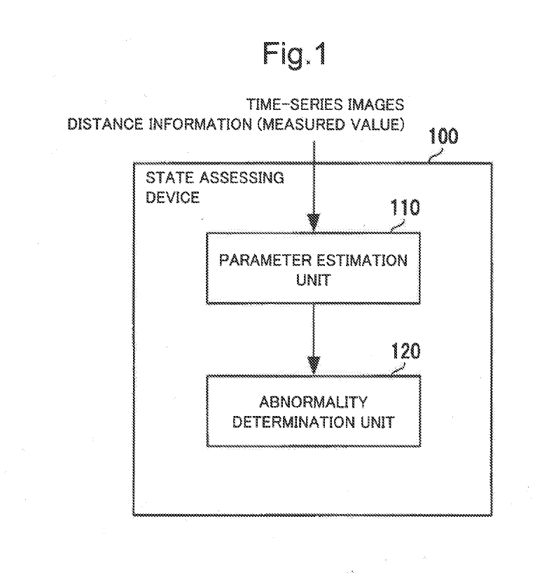

A state assessing device, a state assessing method, and a program therefor according to embodiments of the present invention are described below with reference to FIG. 1 to FIG. 7.

### First Example Embodiment

### [Device Configuration]

First, using FIG. 1, a configuration of the state assessing device according to a first example embodiment of the present invention is described. FIG. 1 is a block diagram illustrating the configuration of the state assessing device according to the present example embodiment.

The state assessing device 100 according to the present example embodiment illustrated in FIG. 1 is a device for determining a state of a structure, for example, a structure, such as a tunnel or a bridge, made of concrete. As illustrated in FIG. 1, the state assessing device 100 includes a parameter estimation unit 110 and an abnormality determination unit 120.

The parameter estimation unit 110 estimates, using time-series images obtained by an image taking device taking images of the structure and a measured value of a distance from the image taking device to the structure, a motion parameter representing a relative motion of a surface of the structure with respect to the image taking device. The abnormality determination unit 120 determines an abnormality in the structure by using an estimation result of the motion parameter.

### [Device Operation]

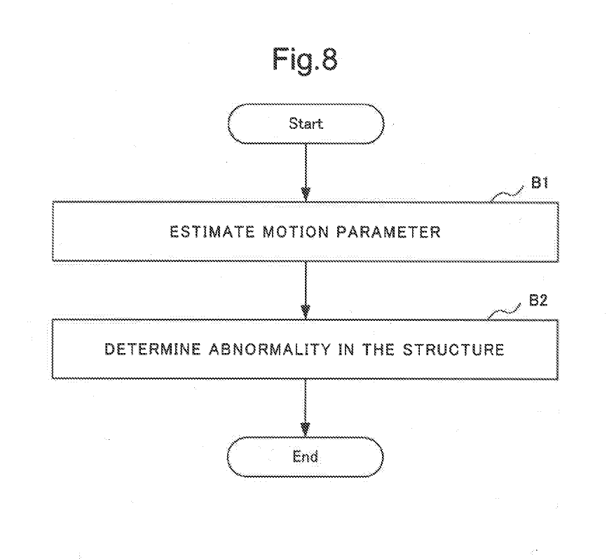

FIG. 8 is a flowchart illustrating an example of an operation of the state assessing device 100. At the starting point of the operation illustrated in FIG. 8, the parameter estimation unit 110 has acquired time-series images obtained by the image taking device taking images of the structure in advance from, for example, the image taking device or the like. The parameter estimation unit 110 has also acquired a measured value of a distance from the image taking device to the structure, measured by a range finder device that measures a distance to a measured object in advance from, for example, the range finder device or the like. The range finder device may be mounted on the image taking device in such a way that a distance, for example, from the image taking device to the structure is able to be measured. The parameter estimation unit 110 first estimates, using time-series images obtained by the image taking device taking images of the structure and the measured value of the distance from the image taking device to the structure, a motion parameter representing a relative motion of a surface of the structure with respect to the image taking device (Step B1). Next, the abnormality determination unit 120 determines an abnormality in the structure by using an estimation result of the motion parameter (Step B2).

In this manner, in the present example embodiment, the time-series images and the measured value of the distance from the image taking device to the structure are used; consequently, an in-plane displacement and an out-of-plane displacement are separated. Furthermore, since an abnormality in the structure is determined on the basis of the motion parameter estimated using the time-series images and the measured value of the distance; thus, an abnormality in the structure may be remotely determined in a non-contact manner without being affected by a condition of the image taking device.

### Second Example Embodiment

### [Configuration of a Device]

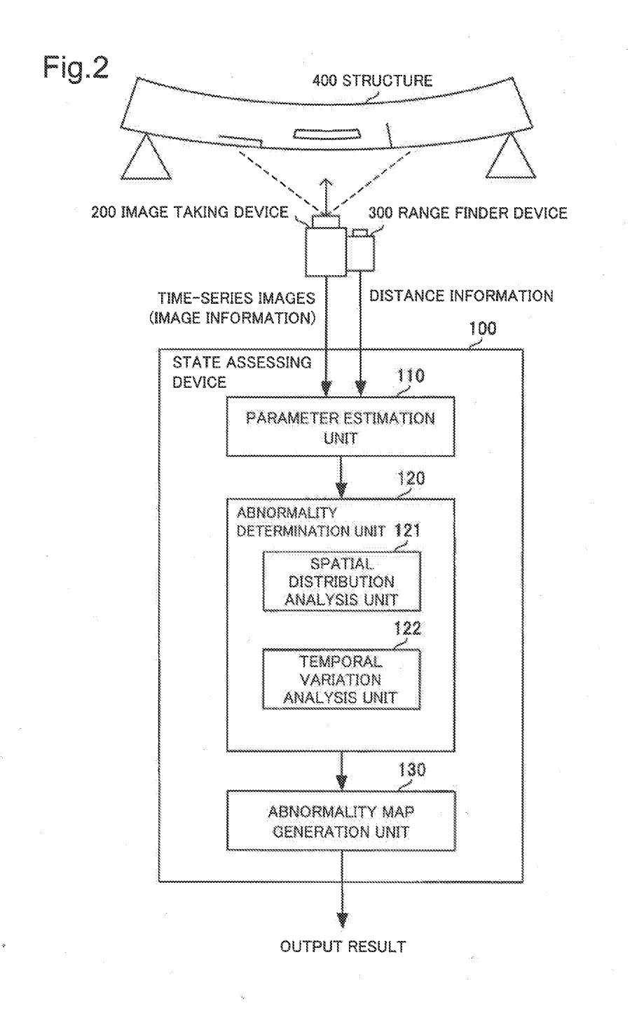

Next, using FIG. 2, a configuration of a state assessing device 100 according to a second example embodiment of the present invention is specifically described. FIG. 2 is a block diagram illustrating a specific configuration of the state assessing device according to the present example embodiment. In the following description, limitations technically desirable for implementation are provided; however, the scope of the invention is not limited to the description given below.

As illustrated in FIG. 2, in the present example embodiment, the state assessing device 100 is connected to an image taking device 200 and a range finder device 300. As illustrated in FIG. 2, in the present example embodiment, the state assessing device 100 includes an abnormality map generation unit 130 in addition to the parameter estimation unit 110 and the abnormality determination unit 120 described above.

In the present example embodiment, the state assessing device 100 may be achieved by a computer such as a personal computer (PC) or a server device as described below. In this case, units included in the state assessing device 100 are achieved by using a central processing unit (CPU) that is an operation resource and storage devices that is storage resources such as memory and an hard disk drive (HDD), all of which are included in the computer, and by causing the CPU to execute a program. This is described later.

In FIG. 2, a structure 400 is illustrated, which is an object of state determination. In an example in FIG. 2, the structure 400 has a beam-like structure supported at two points. Images of a surface before and after a load is applied to the structure 400 are taken by the image taking device 200 as time-series images. The time-series images are input to the parameter estimation unit 110 of the state assessing device 100.

In the present example embodiment, a digital camera and a digital camcorder may be exemplified as specific examples of the image taking device 200. In the image taking device 200, a pixel pitch, a focal length of a lens, a number of pixels, a frame rate, and the like are not particularly limited.

In the present example embodiment, the image taking device 200 may be any device as long as it can measure time-series signals of a surface displacement of the structure in a two-dimensional spatial distribution, and it is not limited to the device (i.e. the digital camera or the video camera described above) that obtains image data in a time order. A device including arrayed laser Doppler sensors, arrayed strain gauges, arrayed vibration sensors, arrayed acceleration sensors or the like is another example of the image taking device 200. In other words, the image taking device 200 may be a device including arrayed surface displacement sensors or arrayed surface strain measurement sensors. When such a device is employed, time-series signals each being spatially two-dimensional and obtained from such arrayed sensors are handled as “time-series images (i.e. image information).”

Furthermore, the range finder device 300 measures a distance from the image taking device 200 to the structure 400. Various types of measuring instruments such as a laser range finder and an ultrasonic range finder may be exemplified as the range finder device 300. The range finder device 300 also outputs distance information (i.e. depth information) that specifies the measured value of the measured distance. The distance information is then input to the parameter estimation unit 110 of the state assessing device 100.

In the present example embodiment, the parameter estimation unit 110 estimates, using the time-series images and the distance information that have been input, a motion parameter representing a relative motion of a surface of the structure 400 (hereinafter, also referred to as a “structure surface”) with respect to the image taking device 200. Specifically, the parameter estimation unit 110 estimates the motion parameter by minimizing an error function representing a time-series variation of the motion parameter. In other words, the parameter estimation unit 110 estimates, using a frame image taken by the image taking device 200 before a load is applied as a reference, the motion parameter that minimizes a difference between the frame image of the reference and a frame image after the load is applied.

In this case, the motion parameter to be estimated may be, for example, a displacement in depth or a translation of the structure surface, and may also be, a direction of a normal to the structure surface. The distance information by the range finder device 300 is used for converting the motion parameter into a value in units of a distance, which has a physical sense. The estimated parameter is input to the abnormality determination unit 120.

The “displacement in depth” of the structure surface is a displacement of the structure surface in the image in a normal direction (i.e. depth direction) of the image. The “translation” of the structure surface is a displacement of the structure surface in the image in a vertical direction, a lateral direction, or a direction of combination these directions of the image. The “normal direction of the structure surface” is a normal direction of the structure surface in a real space.

In the present example embodiment, the abnormality determination unit 120 includes a spatial distribution analysis unit 121 and a temporal variation analysis unit 122. The spatial distribution analysis unit 121 of these units calculates a three-dimensional spatial distribution by computing a spatial derivative of the motion parameter. The spatial distribution analysis unit 121 also performs a comparison between the calculated three-dimensional spatial distribution and a three-dimensional spatial distribution generated in advance, and determines, on the basis of the result of the comparison, an abnormality in the structure 400. Furthermore, the temporal variation analysis unit 122 calculates a temporal variation of the motion parameter. The temporal variation analysis unit 122 performs a comparison between the calculated temporal variation and a temporal variation generated in advance, and determines, on the basis of the result of the comparison, an abnormality in the structure 400.

In other words, in the present example embodiment, the abnormality determination unit 120 determines, on the basis of results of analysis by the spatial distribution analysis unit 121 and the temporal variation analysis unit 122, a position where an abnormality develops in the structure and a type of the abnormality. Furthermore, the abnormality determination unit 120 inputs the position where an abnormality develops in the structure and the type of the abnormality, which has been determined, to the abnormality map generation unit 130.

The abnormality map generation unit 130 generates, on the basis of a result of determination by the abnormality determination unit 120, a map representing the position where the abnormality develops in the structure and the type of the abnormality. The abnormality map generation unit 130 also records the generated map as an abnormality map and outputs the map to the outside. As a result, the state assessing device 100 is capable of detecting and distinguishing an abnormality (i.e. defect) such as a crack, flaking, and an internal cavity by remotely observing the structure 400.

### [Types of Abnormalities in Structure]

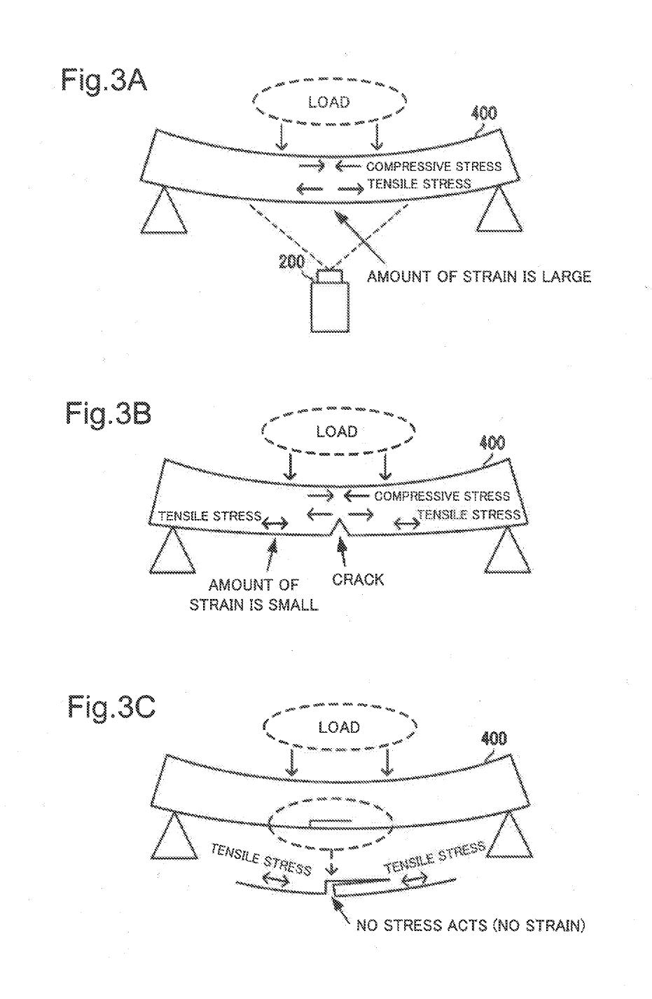

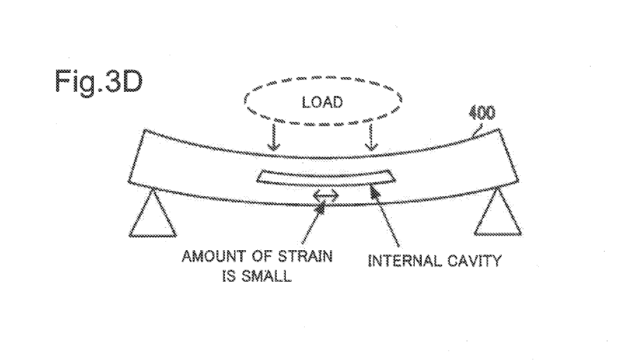

Using FIG. 3A to FIG. 3D, various types of abnormalities developing in the structure 400 and the displacement of the surface of the structure 400 when an abnormality develops are described. FIG. 3A to FIG. 3D are diagrams for explaining a relationship between an abnormal state of the structure and surface displacement, and each of them illustrates a case in a different abnormal state.

The structure 400 illustrated in FIG. 3A to FIG. 3D is a beam-like structure supported at two points as in the example in FIG. 2, and the structure 400 is illustrated as a side view in each figure. In addition, in FIG. 3A to FIG. 3D, the image taking device 200 is a device similar to the image taking device 200 illustrated in FIG. 2, and is arranged so as to taken an image of a bottom surface of the structure 400. The image taking device 200 is illustrated only in FIG. 3A.

When no abnormality develops in the structure 400 and the structure 400 is sound, as illustrated in FIG. 3A, when a vertical load is applied on an upper surface of the structure 400, a compressive stress acts in the upper surface of the structure while a tensile stress acts in the bottom surface. In a condition in which similar stresses act, the state of a structure will be similar even if the structure is not a beam-like structure supported at two points.

Compared with this, when there is a crack on the bottom surface of the structure 400 as illustrated in FIG. 3B, the opening displacement due to the load becomes larger at the cracked part. In contrast, around the cracked part, no stress is transmitted because of the presence of the cracked part; consequently, the tensile stress in the bottom surface of the structure 400 becomes smaller compared with that in the sound state illustrated in FIG. 3A.

If there is flaking inside the structure 400 on the side of the bottom surface as illustrated in FIG. 3C, when the structure 400 is observed from the side of the bottom surface, an appearance similar to that in the case where a crack develops as illustrated in FIG. 3B is observed. However, when there is flaking, no stress is transmitted between the flaked part and the part above it. Therefore, between before and after the load is applied, the flaked part just makes a translation in a certain direction by a certain amount, and a strain, which is a spatial derivative of the displacement, does not occur at the flaked part. Thus, a crack and flaking become able to be distinguished by using information on the strain. The information on the strain is derived by computing a spatial derivative of the displacement that occurs at the flaked part between before and after the load is applied.

When there is a cavity inside the structure 400 as illustrated in FIG. 3D, the internal cavity blocks transmission of a stress; consequently, the stress on the bottom surface of the structure 400 becomes smaller. Accordingly, the strain, the amount of which is computed from the image, becomes smaller; thus, it is possible to detect an internal cavity that is not directly visible from the outside of the structure by observing the strain.

### [Calculation Example of Motion Parameter]

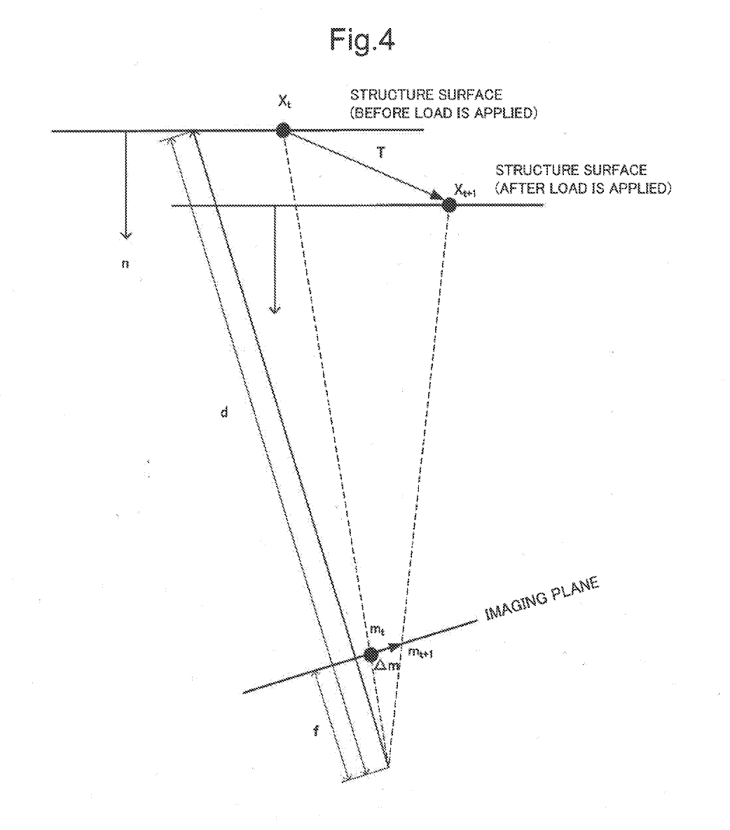

Next, using FIG. 4, an estimation process of a motion parameter by the parameter estimation unit 110 is specifically described. FIG. 4 is a diagram for explaining the estimation process of the motion parameter in the present example embodiment. FIG. 4 illustrates a relationship between a surface of the structure in a case where a deflection occurs in the structure due to a load and an imaging plane at a position where an image is taken from the side of the bottom surface of the structure.

In FIG. 4, an image taking device having a focal length f is set at a distance d from the structure surface. In FIG. 4, Xₜ and Xₜ₊₁ represent three-dimensional coordinates of one point on the structure surface before and after the load is applied (i.e. at the time t and the time t+1), respectively, and mₜ and mₜ₊₁ represent coordinates (i.e. image coordinates) on the imaging plane, which are obtained by observing Xₜ and Xₜ₊₁, respectively, on the imaging plane. The distance d is assumed to be measured by the range finder device 300, and the focal length f is assumed to be measured in advance by a camera calibration.

In the case of an example in FIG. 4, it is assumed that the image taking device 200 is assumed to be not exactly directed perpendicularly to the structure, and a tilt angle of the structure surface with respect to the image taking device 200 is assumed to be unknown. The present example embodiment is different from the techniques of NPL 2 and NPL 3, which are not able to handle such conditions. The state in which the image taking device is not exactly directed perpendicularly to the structure means that an optical axis direction of the image taking device does not coincide with a normal direction n of the structure surface. The state in which the tilt angle of the structure surface with respect to the image taking device is unknown means that the normal direction n of the image taking device is unknown. While the measured distance d may not be exactly a distance from the image taking device to the point Xₜ, in the following description, the distance from the image taking device to the point Xₜ is assumed to be d.

The structure surface is assumed to be displaced due to a load in a real space, and an amount of the translation is denoted by T. The structure surface accordingly is assumed to make a translation on the image as a result, and the displacement of the structure surface generated on the imaging plane as two-dimensional spatial distribution is denoted by Δm=mₜ₊₁−mₜ. Generally speaking, a deflection in a structure corresponds to a displacement in the z direction (i.e. vertical direction) in a real space; however, in the following description, even when the displacement of the structure surface on an image is just expressed as “deflection” or “translation T”, the displacement assumed to include all displacements in the x direction, the y direction, and the z direction in a real space. The x direction and the y direction are directions orthogonal to each other, and these directions are also orthogonal to the z direction.

In the present example embodiment, the motion parameters estimated by the parameter estimation unit 110 are assumed to be, for example, a translation T=[Tₓ, T_{y}, T_{z}]^{T} and a normal direction n=[nₓ, n_{y}, 1]^{T} of the structure surface. The superscript T represents a transposition.

First, relationships between the three-dimensional coordinates Xt=[xₜ, yₜ, zₜ]^{T} and Xₜ₊₁=Xₜ+T, and image coordinates mₜ and mₜ₊₁ are represented by Math. 1 and Math. 2 described below.

$$\begin{matrix}{m}_{t} = \frac{f}{{z}_{t}} {X}_{t} & [ Math . 1 ] \\ {m}_{t + 1} = \frac{f}{{z}_{t} + {T}_{z}} ( {X}_{t} + T ) & [ Math . 2 ]\end{matrix}$$

As illustrated in FIG. 4, Xₜ is a point on a plane that exists at a distance d and has a normal line n; therefore, the following Math. 3 holds.

n^{T}Xₜ=d [Math. 3]

From Math. 1 and Math. 3, Math. 4 is derived as described below.

$${z}_{t} = \frac{fd}{{n}^{T} {m}_{t}} \qquad [ Math . 4 ]$$

Eliminating Xₜ in Math. 1 and Math. 2 described above and substituting Math. 4 above into the resultant equation gives Math. 5 as described below.

$$\frac{fd}{{n}^{T} {m}_{t}} ( {m}_{t + 1} - {m}_{t} ) + ( {T}_{z} {m}_{t + 1} - fT ) = 0 \qquad [ Math . 5 ]$$

In Math. 5 above, the number of unknowns is five (i.e. three unknowns for T and two unknowns for n) and the number of obtained equations is two. In other words, if three or more displacements Δm=mₜ₊₁−mₜ of the structure surface on the image can be measured in the time-series images, the translation T and the normal direction n can be estimated by solving Math. 5 described above by means of the least-squares method.

In the above description, a projection relationship between three-dimensional coordinates and image coordinates is used; however, a temporal variation model of image coordinates may be used for calculation as described below. In other words, assuming that image displacement Δm is a time derivative of the image coordinates mₜ and the translation T is a time derivative of the three-dimensional coordinates Xₜ, Δm is represented by Math. 6 described below.

$$Δ m = \frac{d {m}_{t}}{dt} = \frac{f}{{z}_{t}} \frac{{dX}_{t}}{dt} - \frac{f}{{z}_{t}^{2}} \frac{{dz}_{t}}{dt} {X}_{t} = \frac{f}{{z}_{t}} T - \frac{{T}_{z}}{{z}_{t}} {m}_{t} \qquad [ Math . 6 ]$$

Therefore, by substituting Math. 4 above into Math. 6 described above, the translation T and the direction of the normal n can be estimated by means of the least-squares method in a similar manner.

In order to solve Math. 4 or Math. 6 described above, the image displacement Δm is required to be measured. As a measurement method for the image displacement Δm, an existing method is able to be used. For example, measurement of the image displacement Δm can be achieved by applying an image correlation method to the time-series images or by calculating an optical flow of the time-series images. The measurement of the image displacement Δm can be achieved using a method including extracting a corner or an image feature in scale-invariant feature transform (SIFT) or the like and searching for a corresponding point. In this case, the parameter estimation unit 110 also operates as an image displacement estimation unit.

A method using an optical flow equation is an example of a method not using the image displacement Δm. In this case, assuming that differential images differentiated in the lateral direction and in the vertical direction of an image at the time t are Ix and Iy, respectively, and that a difference image between images of the time t and the time t+1 is It, the optical flow equation is known to be represented by Math. 7 described below.

[Ix,Iy]Δm+It=0 [Math. 7]

In Math. 7 described above, since the third component of Δm is 0, the third component is omitted and Δm is treated as a two-dimensional vector.

By substituting Math. 6 described above into Math. 7 described above and eliminating Δm, the translation T and the normal direction n can be directly estimated from the differential image and the difference image. Since Math. 7 described above gives one constraint for a single point, solution by the least-squares method using five or more points enables estimation of the translation T and the normal direction n.

In this case, the parameter estimation unit 110 also operates as an image point selection unit that selects image points with which the optical flow equation holds.

For the least-squares method, to remove an influence of an outlier, various types of robust estimation methods, such as random sample consensus (RANSAC), or M-estimation, may be used.

In the description above, as the motion parameters, the translation T=[Tₓ, T_{y}, T_{z}]^{T} and the normal direction n=[nₓ, n_{y}, 1]^{T} of the structure surface are used. However, in the present example embodiment, more motion parameters may be estimated according to the conditions of the structure and the image taking device, or conversely, the number of the motion parameters may be limited.

For example, when a more complex motion is expected, a rotation matrix may be added as a motion parameter, or a quadric surface may be applied instead of a flat surface. For example, when the image taking device is directed perpendicularly to the structure surface highly accurately, the translation T may not be a three-dimensional vector, and may only have a single variable in the z direction (i.e. deflection) instead as described in the aforementioned NPL 2 and NPL 3.

### [Specific Examples of Abnormality Determination]

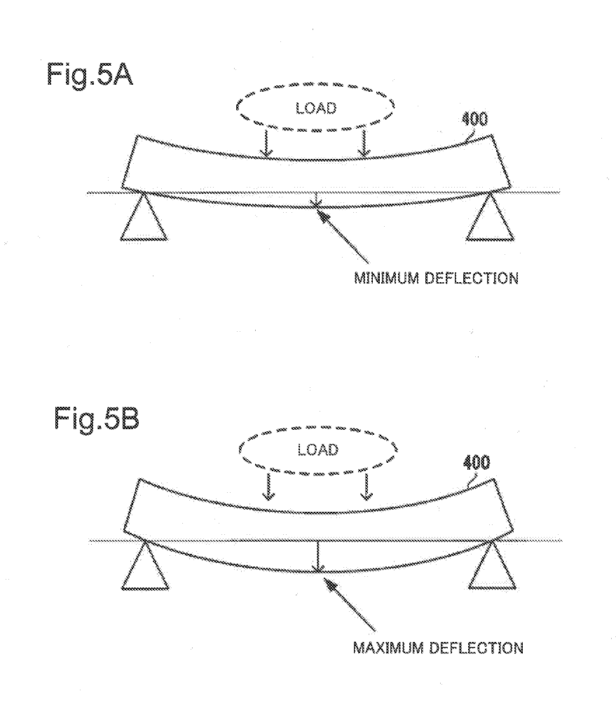

Next, using FIG. 5A and FIG. 5B, abnormality determination using the motion parameters by the abnormality determination unit 120 is specifically described. FIG. 5A and FIG. 5B are diagrams for explaining a deterioration determination process using the motion parameter in the present example embodiment: FIG. 5A illustrates a state in which an amount of deflection of a structure is sound; FIG. 5B illustrates a state in which an amount of deflection of a structure has deteriorated.

In the present example embodiment, the abnormality determination unit 120 analyzes the motion parameters by the spatial distribution analysis unit 121 and the temporal variation analysis unit 122, and thereby performs a process of pattern matching with values that vary in time series or stress distributions stored in advance. Thus, the four states illustrated in FIG. 3A to FIG. 3D are determined.

As an example, a determination process using an amount of a deflection (i.e. translation T) is described. First, as illustrated in FIG. 5A and FIG. 5B, when the structure 400 deteriorates and loses elasticity, the amount of the deflection becomes greater in the deteriorated state (FIG. 5B) than in the sound state (FIG. 5A). In contrast, when there is a cavity inside the structure 400, transmission of a stress is cut off in the part around the internal cavity; consequently, the amount of the deflection in terms of a displacement in the z direction becomes smaller than in the sound state in which no cavity exists inside. In other words, when there is a cavity inside the structure 400, the displacement in the z direction will have a different horizontal distribution from that in the sound state.

Therefore, the spatial distribution analysis unit 121 compares the amount or the horizontal distribution of the deflection with a threshold value stored in advance or patterns of the displacement around an internal cavity stored in advance, and determines whether the amount of the deflection has deteriorated.

For example, the spatial distribution analysis unit 121 determines whether the estimated amount of the deflection is larger than the threshold value. The spatial distribution analysis unit 121 first rotates, enlarges, or scales down patterns, which are stored in advance, of the displacement around an internal cavity in the x direction, the y direction, and the z direction. The spatial distribution analysis unit 121 then performs a pattern matching process in which obtained patterns are matched with a displacement distribution map of the input motion parameters and a differential displacement distribution map thereof, or a threshold value process with respect to the displacement distribution map and the differential displacement distribution map.

Subsequently, the spatial distribution analysis unit 121 may generate, on the basis of the result of the pattern matching process or the threshold value process, a two-dimensional distribution that specifies a type and a degree of an abnormality at each point on the structure surface, and may determine a three-dimensional position of the internal cavity on the basis of the generated two-dimensional distribution. As a pattern matching process, a correlation operation and various types of statistical operational approaches may be used. In computing a derivative of the displacement, a spatial smoothing filter may be used to reduce noises in computing a spatial derivative.

A case in which the normal direction n is used as a motion parameter is also described. In this case, a flat surface deflects and becomes a curved surface in conjunction with, for example, increase in the amount of the deflection; consequently, the center of deflection and other areas will have different distributions of normals. For example, when the amount of the deflection is small (FIG. 5A), the normal direction at the center of the deflection and the normal direction of the peripheral area are approximately the same. In contrast, when the amount of the deflection is large (FIG. 5B), the normal direction of the peripheral area radially varies from that at the center of the deflection. In this case, the spatial distribution analysis unit 121 therefore compares the distribution of the normals with patterns of the distributions of the normals around an internal cavity stored in advance, and determines whether deterioration has occurred.

The temporal variation analysis unit 122 determines a deteriorated state by analyzing a time-series variation of the motion parameter. For example, since transmission of a stress is cut off in a part around a cavity, a response in terms of structural deformation in the portion becomes slower than that in a sound portion. Accordingly, the temporal variation analysis unit 122 first generates displacement distribution maps of vibration frequencies, amplitudes, and phases with respect to displacement components in the x direction, the y direction, and the z direction and the derivative information thereof at parts of the structure surface. The temporal variation analysis unit 122 then rotates, enlarges, or scales down patterns, which are stored in advance, of the vibration frequencies, amplitudes, and phases around an internal cavity, and performs a pattern matching process in which obtained patterns are matched with a displacement distribution map, or a threshold value process with respect to a displacement distribution map. Subsequently, the temporal variation analysis unit 122 determines a three-dimensional position of the internal cavity on the basis of the result of the pattern matching process or the threshold value process. In the process (i.e. processing of time responses) of deriving the vibration frequencies, amplitudes, and phases, various types of frequency analysis methods such as the fast Fourier transform method or the wavelet transform method may be used.

The abnormality determination unit 120 determines, on the basis of an analysis result by the spatial distribution analysis unit 121 and the temporal variation analysis unit 122, a part where the abnormality occurs in the structure and a type of the abnormality. The determination result is sent to the abnormality map generation unit 130. The abnormality map generation unit 130 may generate, on the basis of the aforementioned various types of value information, an abnormality map that represents a degree of the defect. The abnormality map generation unit 130 may generate an abnormality map that represents, for example, a width or depth of a crack, a dimension of flaking, a dimension or a depth from a surface of an internal cavity.

The abnormality map generation unit 130 may be built into the abnormality determination unit 120. In this case, the abnormality map generation unit 130 may perform determination of a defect state of a structure, which is performed by the abnormality determination unit 120, when the abnormality map generation unit 130 generates an abnormality map (x,y,z). In other words, in this case, the abnormality map generation unit 130 obtains analysis data from the spatial distribution analysis unit 121 and the temporal variation analysis unit 122, and determines the defect state on the basis of the analysis data.

The result output by the abnormality map generation unit 130 may be information in a form directly visible for a human by means of a display device, or information in a form that may be read into another external device.

### [Device Operation]

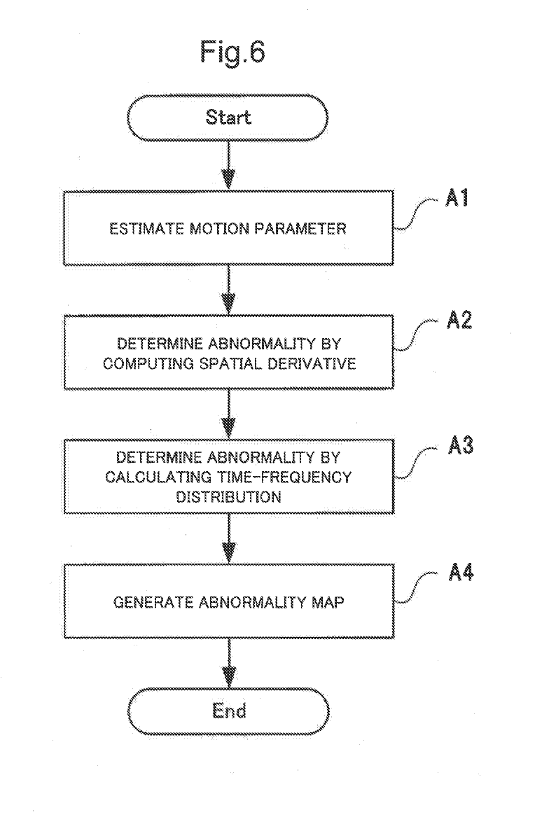

Next, an operation of the state assessing device 100 according to the present example embodiment is described using FIG. 6. FIG. 6 is a flowchart illustrating the operation of the state assessing device according to the present example embodiment. In the description below, FIG. 1 to FIG. 5B are considered where appropriate. In the present example embodiment, a state assessing method is performed by operating the state assessing device 100. Therefore, the following description of the operation of the state assessing device 100 is substituted for a description of the state assessing method according to the present example embodiment.

First, as a precondition, the image taking device 200 takes time-series images before and after a load is applied. In other words, the image taking device 200 takes a frame image before the load is applied, which are used as a reference for calculating amounts of displacement between before and after the load is applied, and further takes frame images from when application of the load is started until when application of the load is finished, and outputs the taken frame images to the state assessing device 100. The range finder device 300 measures a distance between the image taking device 200 and the surface of the structure 400 when the image taking device 200 takes the reference frame image and outputs the measured distance to the state assessing device 100.

As illustrated in FIG. 6, the parameter estimation unit 110 first estimates, using time-series images output from the image taking device 200 and the distance information output from the range finder device 300, relative motion parameters between the image taking device 200 and the structure surface at the time when the images are taken (Step A1).

Next, in the abnormality determination unit 120, the spatial distribution analysis unit 121 computes spatial derivatives of the motion parameters estimated in the step A1, and calculates a three-dimensional spatial distribution. The spatial distribution analysis unit 121 then compares the calculated three-dimensional spatial distribution with a three-dimensional spatial distribution generated in advance, and determines, on the basis of the comparison result, an abnormality in the structure 400 (Step A2).

Specifically, in the step A2, the spatial distribution analysis unit 121 compares the amount or the horizontal distribution of the deflection with a threshold value stored in advance or patterns, stored in advance, of the displacement around an internal cavity, and determines whether the amount of the deflection has deteriorated. The spatial distribution analysis unit 121 then generates, on the basis of the determination result, a two-dimensional distribution that specifies a type and a degree of an abnormality at each point on the structure surface, and inputs the generated two-dimensional distribution to the abnormality map generation unit 130. When the abnormality determination unit 120 has not obtained a sufficient number of time-series images for state determination, the step A1 is performed again after the sufficient number of time-series images are obtained.

Next, in the abnormality determination unit 120, the temporal variation analysis unit 122 calculates a temporal variation of the motion parameters, performs comparison between the calculated temporal variation and a temporal variation generated in advance, and determines an abnormality in the structure 400 on the basis of the result of the comparison (Step A3). In other words, the temporal variation analysis unit 122 determines a deteriorated state by analyzing a time-series variation of the motion parameter (i.e. time response of the displacement of the structure surface).

Specifically, the temporal variation analysis unit 122 first generates displacement distribution maps of vibration frequencies, amplitudes and phases with respect to displacement components in the x direction, the y direction and the z direction, and the derivative information thereof at portions of the structure surface. The temporal variation analysis unit 122 then rotates, enlarges, or scales down patterns, which are stored in advance, of vibration frequencies, amplitudes, and phases around an internal cavity, and performs a pattern matching process on the displacement distribution map in which the patterns are matched with the displacement distribution map, or a threshold value process with respect to the displacement distribution map, and generates a time-frequency distribution.

The time-frequency distribution is defined by amplitudes and phases. Therefore, when the amplitudes and the phases in the time-frequency distribution have different characteristics depending to positions in the structure surface, the temporal variation analysis unit 122 determines a state of a crack, flaking, and an internal cavity from these characteristics. The temporal variation analysis unit 122 then inputs the calculation result of the time-frequency distribution and the determination result of the defect to the abnormality map generation unit 130.

Subsequently, the abnormality map generation unit 130 generates an abnormality map (x,y,z) on the basis of the information input in the step A2 and the information input in the step A3 (Step A4). Specifically, the information input by the spatial distribution analysis unit 121 and the information input by the temporal variation analysis unit 122 are data relating to points (x,y,z) of the X-Y-Z coordinates. This information represents determination results of the states of the structure by the spatial distribution analysis unit 121 and the temporal variation analysis unit 122 in the abnormality determination unit 120.

These determination results include the amounts of displacements or the displacement distribution map in the X direction, the amounts of displacements or the displacement distribution map in the Y direction, the amounts of displacements or the displacement distribution map in the Z direction, and the amounts of the differential displacements or the differential displacement distribution map in each of those directions. Therefore, even if there is a missing piece in the data of the determination result, for example, for a reason that determination based on the amount of displacement in the Y direction is not able to be made or for another reason, the abnormality map generation unit 130 is capable of determining, if the determination result based on the amount of displacement and the amount of the differential displacement in the X direction are obtained, the state of the concerning position in the X-Y-Z coordinates. Then, the abnormality map generation unit 130 may generate an abnormality map (x,y,z) on the basis of this determination.

When determinations based on the displacement in the X direction, the displacement in the Y direction, and the displacement in the Z direction disagree with each other upon determination of the defect state, the abnormality map generation unit 130 may determine the defect state in accordance with the majority rule. The abnormality map generation unit 130 may also determine an item having the largest difference from the threshold value, which is a determination criterion, as the position of a defect.

The abnormality map generation unit 130 may represent, on the basis of the value information, a degree of the defect. The abnormality map generation unit 130 may represent the degree of the defect by means of, for example, a width of a crack, a depth of a crack, a dimension of flaking, a dimension of an internal cavity, a depth from a surface of an internal cavity, or the like.

### Effects of Example Embodiments

As described above, in the present example embodiment, the in-plane displacement of the surface of the structure 400 and the out-of-plane displacement based on the distance between the structure 400 and the image taking device 200 are separated, and only the in-plane displacement is extracted. Thus, according to the present example embodiment, detection of a defect such as a crack, flaking, or an internal cavity, which are distinguished in the detection, in the structure is able to be performed remotely in a non-contact manner with a high degree of accuracy.

### [Program]

A program according to the present example embodiment may be any program as long as the program causes a computer to execute the steps A1 to A4 illustrated in FIG. 6. By installing the program on the computer and executing the program, the state assessing device 100 and the state assessing method according to the present example embodiment can be achieved. In this case, a central processing unit (CPU) of the computer operates as the parameter estimation unit 110, the abnormality determination unit 120, and the abnormality map generation unit 130, and executes processing.

The program according to the present example embodiment may be executed by a computing system including a plurality of computers. In this case, each of the computers may operate, for example, as any of the parameter estimation unit 110, the abnormality determination unit 120, and the abnormality map generation unit 130.

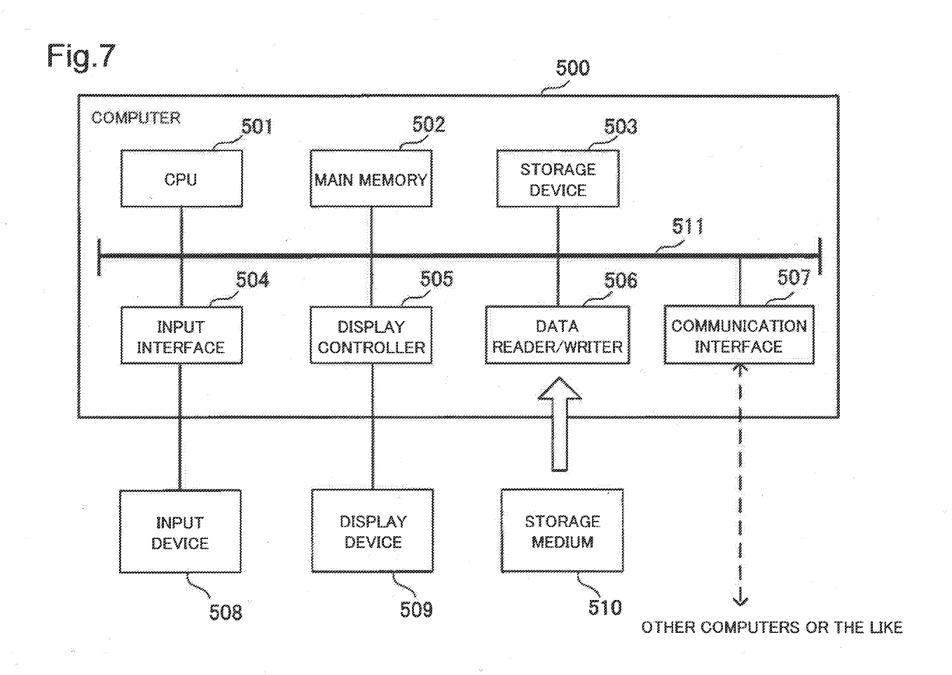

A computer achieving the state assessing device 100 by executing the program according to the present example embodiment is described below using FIG. 7. FIG. 7 is a block diagram illustrating an example of the computer achieving the state assessing device according to the present example embodiment.

As illustrated in FIG. 7, a computer 500 includes a CPU 501, a main memory 502, a storage device 503, an input interface 504, a display controller 505, a data reader/writer 506, and a communication interface 507. These units are connected to each other via a bus 511 in such a way that they can communicate data with each other.

The CPU 501 loads the program (i.e. codes) according to the present example embodiment stored in the storage device 503 into the main memory 502, and executes it in a predetermined order, thereby performing various types of operations. The main memory 502 is typically a volatile storage device such as dynamic random access memory (DRAM). The program according to the present example embodiment is provided in a state in which the program is stored in a computer readable storage medium 510. The program according to the present example embodiment may be a program distributed on the Internet to which connection is made via the communication interface 507.

A semiconductor storage device such as flash memory in addition to a hard disk drive may be a specific example of the storage device 503. The input interface 504 mediates data transmission between the CPU 501 and the input device 508 such as a keyboard or a mouse. The display controller 505 is connected with a display device 509 and controls displaying on the display device 509.

The data reader/writer 506 mediates data transmission between the CPU 501 and the storage medium 510, reads the program from the storage medium 510, and writes a result of processing on the computer 500 to the storage medium 510. The communication interface 507 mediates data transmission between the CPU 501 and other computers.

Specific examples of the storage medium 510 may be a general-purpose semiconductor storage device such as a compact flash (CF, (registered trademark)) and an secure digital (SD, registered trademark), a magnetic storage medium such as a flexible disk, or an optical storage medium such as a compact disk read only memory (CD-ROM).

The state assessing device 100 according to the present example embodiment may achieved by, instead of a computer on which the program is installed, hardware such as a circuit having a function of the units. Furthermore, the state assessing device 100 may be achieved in part by a program and the remainder may be achieved by hardware.

Part or all of the aforementioned example embodiments may be expressed by (Supplementary Note 1) to (Supplementary Note 15) described below; however, the example embodiments are not limited to the following description.

### (Supplementary Note 1)

A state assessing device including:

parameter estimation means for estimating, using time-series images obtained by an image taking device taking images of a structure and a measured value of a distance from the image taking device to the structure, a motion parameter representing a relative motion of a surface of the structure with respect to the image taking device; and

abnormality determination means for determining an abnormality in the structure by using an estimation result of the motion parameter.

### (Supplementary Note 2)

The state assessing device according to Supplementary Note 1, wherein

the parameter estimation means estimates the motion parameter by minimizing an error function representing a time-series variation of the motion parameter.

### (Supplementary Note 3)

The state assessing device according to Supplementary Note 1 or Supplementary Note 2, wherein

the abnormality determination means calculates a three-dimensional spatial distribution by computing a spatial derivative of the motion parameter, makes a comparison between the calculated three-dimensional spatial distribution and a three-dimensional spatial distribution generated in advance, and determines, based on a result of the comparison, an abnormality in the structure.

### (Supplementary Note 4)

The state assessing device according to any one of Supplementary Notes 1 to 3, wherein

the abnormality determination means calculates a temporal variation of the motion parameter, makes a comparison between the calculated temporal variation and a temporal variation generated in advance, and determines, based on a result of the comparison, an abnormality in the structure.

### (Supplementary Note 5)

The state assessing device according to any one of Supplementary Notes 1 to 4, further including:

abnormality map generating means for generating, based on a determination result by the abnormality determination means, a map representing a position where the abnormality occurs in the structure and a type of the abnormality.

### (Supplementary Note 6)

A state assessing method including:

performing parameter estimation including estimating, using time-series images obtained by an image taking device taking images of a structure and a measured value of a distance from the image taking device to the structure, a motion parameter representing a relative motion of a surface of the structure with respect to the image taking device; and

performing abnormality determination including determining an abnormality in the structure by using an estimation result of the motion parameter.

### (Supplementary Note 7)

The state assessing method according to Supplementary Note 6, wherein

the parameter estimation includes estimating the motion parameter by minimizing an error function representing a time-series variation of the motion parameter.

### (Supplementary Note 8)

The state assessing method according to Supplementary Note 6 or Supplementary Note 7, wherein

the abnormality determination includes calculating a three-dimensional spatial distribution by computing a spatial derivative of the motion parameter, making a comparison between the calculated three-dimensional spatial distribution and a three-dimensional spatial distribution generated in advance, and determining, based on a result of the comparison, an abnormality in the structure.

### (Supplementary Note 9)

The state assessing method according to any one of Supplementary Notes 6 to 8, wherein

the abnormality determination further includes calculating a temporal variation of the motion parameter, making a comparison between the calculated temporal variation and a temporal variation generated in advance, and determining, based on a result of the comparison, an abnormality in the structure.

### (Supplementary Note 10)

The state assessing method according to any one of Supplementary Notes 6 to 9, further including:

performing abnormality map generation including generating, based on a determination result by the abnormality determination, a map representing a position where the abnormality occurs in the structure and a type of the abnormality.

### (Supplementary Note 11)

A storage medium storing a program causing a computer to execute:

a parameter estimation process of estimating, using time-series images obtained by taking images of a structure by an image taking device and a measured value of a distance from the image taking device to the structure, a motion parameter representing a relative motion of a surface of the structure with respect to the image taking device; and

an abnormality determination process of determining an abnormality in the structure using an estimation result of the motion parameter.

### (Supplementary Note 12)

The storage medium according to Supplementary Note 11, wherein

the parameter estimation process estimates the motion parameter by minimizing an error function representing a time-series variation of the motion parameter.

### (Supplementary Note 13)

The storage medium according to Supplementary Note 11 or Supplementary Note 12, wherein

the abnormality determination process calculates a three-dimensional spatial distribution by computing a spatial derivative of the motion parameter, makes a comparison between the calculated three-dimensional spatial distribution and a three-dimensional spatial distribution generated in advance, and determines, based on a result of the comparison, an abnormality in the structure.

### (Supplementary Note 14)

The storage medium according to any one of Supplementary Notes 11 to 13, wherein

the abnormality determination process further calculates a temporal variation of the motion parameter, makes a comparison between the calculated temporal variation and a temporal variation generated in advance, and determines, based on a result of the comparison, an abnormality in the structure.

### (Supplementary Note 15)

The storage medium according to any one of Supplementary Notes 11 to 14, wherein

the program causes the computer to further execute

an abnormality map generation process of generating, based on a determination result by the abnormality determination process, a map representing a position where the abnormality occurs in the structure and a type of the abnormality are generated.

The present invention has been described above with reference to the example embodiments; however, the present invention is not limited to the aforementioned example embodiments. Various modifications that could be understood by those skilled in the art may be made to the configurations or details of the present invention within the scope of the present invention.

This application claims priority to Japanese Patent Application No. 2016-124877 filed on Jun. 23, 2016, the entire disclosure of which is incorporated herein.

### INDUSTRIAL APPLICABILITY

As described above, according to the present invention, an abnormality in a structure may be remotely determined in a non-contact manner without being affected by a condition of an image taking device while an in-plane displacement and an out-of-plane displacement are separated. The present invention is useful in a field that requires state determination of a structure such as a tunnel or a bridge.

### REFERENCE SIGNS LIST

100 state assessing device
110 parameter estimation unit
120 abnormality determination unit
121 spatial distribution analysis unit
122 temporal variation analysis unit
130 abnormality map generation unit
200 image taking device
300 range finder device
500 computer
501 CPU
502 main memory
503 storage device
504 input interface
505 display controller
506 data reader/writer
507 communication interface
508 input device
509 display device
510 storage medium
511 bus

What is claimed is:

1. A state assessing device, comprising:
a memory that stores a set of instructions; and
at least one processor configured to execute the set of instructions to:
estimate, using time-series images obtained by an image taking device taking images of a structure and a measured value of a distance from the image taking device to the structure, a motion parameter representing a relative motion of a surface of the structure with respect to the image taking device; and
determine an abnormality in the structure by using an estimation result of the motion parameter.

2. The state assessing device according to claim 1, wherein
the at least one processor is configured to
estimate the motion parameter by minimizing an error function representing a time-series variation of the motion parameter.

3. The state assessing device according to claim 1, wherein
the at least one processor is configured to:
calculate a three-dimensional spatial distribution by computing a spatial derivative of the motion parameter;
make a comparison between the calculated three-dimensional spatial distribution and a three-dimensional spatial distribution generated in advance; and
determine, based on a result of the comparison, an abnormality in the structure.

4. The state assessing device according to claim 1, wherein
the at least one processor is configured to:
calculate a temporal variation of the motion parameter;
make a comparison between the calculated temporal variation and a temporal variation generated in advance; and
determine, based on a result of the comparison, an abnormality in the structure.

5. The state assessing device according to claim 1, further comprising:
the at least one processor is configured to
generate, based on a determination result of the abnormality, a map representing a position where the abnormality occurs in the structure and a type of the abnormality.

6. A state assessing method, comprising:
performing parameter estimation including estimating, using time-series images obtained by an image taking device taking images of a structure and a measured value of a distance from the image taking device to the structure, a motion parameter representing a relative motion of a surface of the structure with respect to the image taking device; and
performing abnormality determination including determining an abnormality in the structure by using an estimation result of the motion parameter.

7. The state assessing method according to claim 6, wherein
the parameter estimation includes estimating the motion parameter by minimizing an error function representing a time-series variation of the motion parameter.

8. The state assessing method according to claim 6, wherein
the abnormality determination includes calculating a three-dimensional spatial distribution by computing a spatial derivative of the motion parameter, making a comparison between the calculated three-dimensional spatial distribution and a three-dimensional spatial distribution generated in advance, and determining, based on a result of the comparison, an abnormality in the structure.

9. The state assessing method according to claim 6, wherein
the abnormality determination further includes calculating a temporal variation of the motion parameter, making a comparison between the calculated temporal variation and a temporal variation generated in advance, and determining, based on a result of the comparison, an abnormality in the structure.

10. The state assessing method according to claim 6, further comprising:
performing abnormality map generation including generating, based on a determination result by the abnormality determination, a map representing a position where the abnormality occurs in the structure and a type of the abnormality.

11. A non-transitory computer readable storage medium storing a program causing a computer to execute:
a parameter estimation process of estimating, using time-series images obtained by taking images of a structure by an image taking device and a measured value of a distance from the image taking device to the structure, a motion parameter representing a relative motion of a surface of the structure with respect to the image taking device; and
an abnormality determination process of determining an abnormality in the structure using an estimation result of the motion parameter.

12. The storage medium according to claim 11, wherein
the parameter estimation process estimates the motion parameter by minimizing an error function representing a time-series variation of the motion parameter.

13. The storage medium according to claim 11, wherein
the abnormality determination process calculates a three-dimensional spatial distribution by computing a spatial derivative of the motion parameter, makes a comparison between the calculated three-dimensional spatial distribution and a three-dimensional spatial distribution generated in advance, and determines, based on a result of the comparison, an abnormality in the structure.

14. The storage medium according to claim 11, wherein
the abnormality determination process further calculates a temporal variation of the motion parameter, makes a comparison between the calculated temporal variation and a temporal variation generated in advance, and determines, based on a result of the comparison, an abnormality in the structure.

15. The storage medium according to claim 11, wherein
the program causes the computer to further execute
an abnormality map generation process of generating, based on a determination result by the abnormality determination process, a map representing a position where the abnormality occurs in the structure and a type of the abnormality.
